(19) United States
(12) Patent Application Publication
(10) Pub. No.: US 2009/0135901 A1
(43) Pub. Date: May 28, 2009

(54) COMPLEXITY ADAPTIVE VIDEO ENCODING USING MULTIPLE REFERENCE FRAMES

(75) Inventors: Oscar Chi Lim Au, Hong Kong (CN); Sui Yuk Lam, Hong Kong (CN)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 12/246,062

(22) Filed: Oct. 6, 2008

Related U.S. Application Data
(60) Provisional application No. 60/990,671, filed on Nov. 28, 2007.

(51) Int. Cl. H04N 7/12; H04N 11/02

(52) U.S. Cl. 375/240.02; 375/240.16; 375/E07.026; 375/E07.104

(57) ABSTRACT

Encoding techniques are provided that consider decoder complexity when encoding video data. A complexity adaptive encoding algorithm encodes video data by encoding current frame data based on reference frame data taking into account an expected computational complexity cost of decoding the current frame data.

### CROSS-REFERENCE TO RELATED APPLICATIONS

This application claims priority to U.S. Provisional Application Ser. No. 60/990,671, filed on Nov. 28, 2007, entitled “COMPLEXITY ADAPTIVE VIDEO ENCODING USING MULTIPLE REFERENCE FRAMES”, the entirety of which is incorporated by reference.

### TECHNICAL FIELD

The subject disclosure relates to encoding techniques that consider decoder complexity when encoding video data.

### BACKGROUND

Jointly developed by and with versions maintained by the ISO/IEC and ITU-T standards organizations, H.264, a.k.a. Advanced Video Coding (AVC) and MPEG-4, Part 10, is a commonly used video coding standard that was designed in consideration of the growing need for higher compression of moving pictures for various applications such as, but not limited to, digital storage media, television broadcasting, Internet streaming and real-time audiovisual communication. H.264 was designed to enable the use of a coded video representation in a flexible manner for a wide variety of network environments. H.264 was further designed to be generic in the sense that it serves a wide range of applications, bit rates, resolutions, qualities and services.

The use of H.264 allows motion video to be manipulated as a form of computer data and to be stored on various storage media, transmitted and received over existing and future networks and distributed on existing and future broadcasting channels. In the course of creating H.264, requirements from a wide variety of applications and associated algorithmic elements were integrated into a single syntax, facilitating video data interchange among different applications.

Compared with previous coding standards MPEG2 and H.263, H.264/AVC possesses better coding efficiency over a wide range of bit rates by employing sophisticated features such as using a rich set of coding modes. In this regard, by introducing many new coding techniques, higher coding efficiency can be achieved; however, such higher coding efficiency is achieved at the expense of higher computational complexity. For instance, techniques such as variable block size and quarter-pixel motion estimation increase encoding complexity significantly. In addition, decoding complexity is significantly increased due to operations such as 6-tap subpixel filtering and deblocking.

In this respect, conventional algorithms, such as fast motion estimation algorithms and mode decision algorithms, have focused on reducing the encoding complexity with negligible coding efficiency degradation. Parallel processing techniques have also been developed that leverage advanced hardware and graphics processing platforms to reduce encoding time further. However, conventional systems have not focused attention on the decoder side.

One conventional system has proposed a rate-distortion-complexity (R-D-C) optimization framework that purports to reduce the number of subpixel interpolation operations performed with only about 0.2 dB loss in PSNR. However, it has been observed that such technique disadvantageously results in a non-smooth motion field due to its employment of direct modification of the motion vectors. In addition to the dissatisfactory introduction of a non-smooth motion field, simultaneous with reducing subpixel interpolation operations, such technique also increases the overhead associated with coding motion vectors, which is not desirable, especially in low bit-rate situations. Moreover, such conventional R-D-C optimization framework is founded on some incorrect assumptions.

Accordingly, it would be desirable to provide a solution for encoding video data that considers decoder complexity at the encoder. The above-described deficiencies of current designs for video encoding are merely intended to provide an overview of some of the problems of today's designs, and are not intended to be exhaustive. Other problems with the state of the art and corresponding benefits of the invention may become further apparent upon review of the following description of various non-limiting embodiments of the invention.

### SUMMARY

A complexity adaptive encoding algorithm selects an optimal reference that exhibits savings or a reduction in decoding complexity. In various embodiments, video data is encoded by encoding current frame data based on reference frame data taking into account an expected computational complexity cost of decoding the current frame data. Encoding is performs that considers decoding computational complexity when selecting between optimal or sub-optimal encoding process(es) during encoding.

In one non-limiting aspect, motion estimation can be applied with pixel or subpixel precision, and either optimal or sub-optimal motion vectors are selected for encoding based on a function of decoding cost metric(s), where optimality is with reference to rate-distortion characteristic(s).

A simplified and/or over-generalized summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the invention in a simplified form as a prelude to the more detailed description that follows.

### BRIEF DESCRIPTION OF THE DRAWINGS

The video encoding techniques in accordance with the invention are further described with reference to the accompanying drawings in which:

FIG. 1 is an exemplary block diagram of a video encoding/decoding system for video data for operation of various embodiments of the invention;

FIG. 2 is an exemplary flow diagram illustrating encoding processes implemented via adaptive complexity techniques;

FIG. 3 is an illustration of some notation used in connection with subpixel motion estimation in H.264;

FIG. 4 is another exemplary flow diagram illustrating encoding processes implemented via adaptive complexity techniques;

FIGS. 5 and 6 illustrate resulting motion fields comparing no use of adaptive complexity techniques with use of adaptive complexity techniques, respectively;

FIG. 7 illustrates rate-distortion performance for different image sequences for different selection of K;

FIG. 8 illustrates the efficacy of the complexity adaptive techniques described herein relative to conventional techniques for difference image sequences;

FIG. 9 illustrates the efficacy of the complexity adaptive techniques with reference to number of interpolation operations required as a result;

FIG. 10 illustrates motion vector distribution as a result of employing the complexity adaptive techniques described herein;

FIG. 11 is a block diagram representing an exemplary non-limiting computing system or operating environment in which the present invention may be implemented; and

FIG. 12 illustrates an overview of a network environment suitable for service by embodiments of the invention.

### DETAILED DESCRIPTION

### Overview

As discussed in the background, conventional advanced video encoding algorithms, such as H.264 video encoding, have focused on optimizing encoding efficiency at considerable expense to computational complexity. In this regard, the H.264/AVC video coding standard achieves significant improvements in coding efficiency by introducing many new coding techniques. As a consequence, however, computational complexity is increased during both the encoding and decoding process. While fast motion estimation and fast mode decision algorithms have been proposed that endeavor to reduce encoder complexity while maintaining coding efficiency, these algorithms fail to mitigate increasing decoder complexity.

Accordingly, in various non-limiting embodiments, encoding techniques are provided that consider resulting decoding complexity. Techniques are provided that consider how difficult it will be for a decoder to decode a video stream in terms of computational complexity. Using the various non-limiting embodiments described herein, in some non-limiting trials, it is shown that decoding complexity can be reduced by up to about 15% in terms of motion compensation operations, i.e., a highly complex task performed by the decoder, while maintaining rate-distortion (R-D) performance with insubstantial or insignificant degradation in peak signal to noise ratio (PSNR) characteristics, e.g., only about 0.1 dB degradation.

In this regard, in various non-limiting embodiments, the complexity of the H.264/AVC decoder is focused upon instead of the encoder. Motivated in part by the rapidly growing market of embedded devices, which can have disparate hardware configurations for such consuming or decoding devices, various algorithmic solutions are provided herein for enhanced versatility.

In one implementation, a joint R-D-C optimization framework is modified to preserve the true motion information of motion vectors. In this regard, the techniques redefine the complexity model carried out during encoding in a way that preserves motion vector data at the decoder. Instead of always making the optimal choice from the encoder's perspective, various embodiments of the joint R-D-C optimization framework discussed herein make an acceptable sub-optimal encoding choice according to one or more tradeoffs, which in turn reduces the resulting complexity of decoding the encoded video data.

As a roadmap of what follows, an overview of H.264/AVC motion compensation techniques is first provided that reveals the complexity associated with H.264 interpolation algorithms. Next, some non-limiting details and alternate embodiments of the R-D-C optimization framework are discussed. Some performance metrics are then set forth to illustrate the efficacy of the techniques described herein, and then some representative, but non-limiting, operating devices and networked environments in which one or more aspects of R-D-C optimization framework can be practiced are delineated.

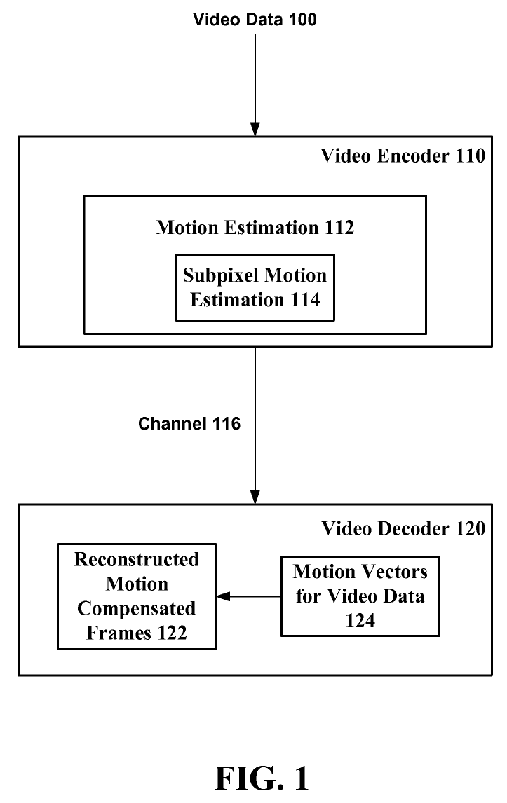

An encoding/decoding system according to the various embodiments described herein is illustrated generally in FIG. 1. Original video data 100 to be compressed is input to a video encoder 110. Video encoder 110 can include multiple encoding modes, such as an inter encoding mode and an intra encoding mode. Inter mode typically determines temporal relationships among the frames of a sequence of input image data and forms motion vectors that efficiently describe those relationships, whereas intra mode determines spatial relationships of pixels within a single image, i.e., forms an efficient representation for areas of an image without a lot of unpredictable variation. In this regard, to generate the motion vectors in inter mode to compress original video data 100, video encoder 110 includes a motion estimation component 112. As mentioned, H.264 includes the ability to perform motion estimation at the sub-pixel level, i.e., half pixel or quarter pixel motion estimation, as represented by component 114.

In one aspect of an H.264 encoder, motion estimation 112 is used to estimate the movement of blocks of pixels from frame to frame and to code associated displacement vectors to reduce or eliminate temporal redundancy. To start, the compression scheme divides the video frame into blocks. H.264 provides the option of motion compensating 16×16-, 16×8-, 8×16-, 8×8-, 8×4-, 4×8-, or 4×4-pixel blocks within each macroblock. Motion estimation 112 is achieved by searching for a good match for a block from the current frame in a previously coded frame. The resulting coded picture is a P-frame.

With H.264, the estimate may also involve combining pixels resulting from the search of two B frames. Searching thus ascertains the best match for where the block has moved from one frame to the next by comparing differences between pixels. To substantially improve the process, subpixel motion estimation 114 can be used, which defines fractional pixels. In this regard, H.264 can use quarter-pixel accuracy for both the horizontal and the vertical components of the motion vectors.

Additional steps can be applied to the video data 100 before motion estimation 112 operates, e.g., breaking the data up into slices and macro blocks. Additional steps can also be applied after encoder 112 operates as well, e.g., further transformation/compression. In either case, encoding and motion compensation results in the production of H.264 P frames. The encoded data can then be stored, distributed or transmitted to a decoding apparatus 120, which can be included in the same or different device as encoding apparatus 110. At decoder 120, motion vectors 124 for the video data are used to reconstruct the original video data 100, or a close estimate of the original video data, with the P frames to form reconstructed motion compensated frames 122 by the decoder 120.

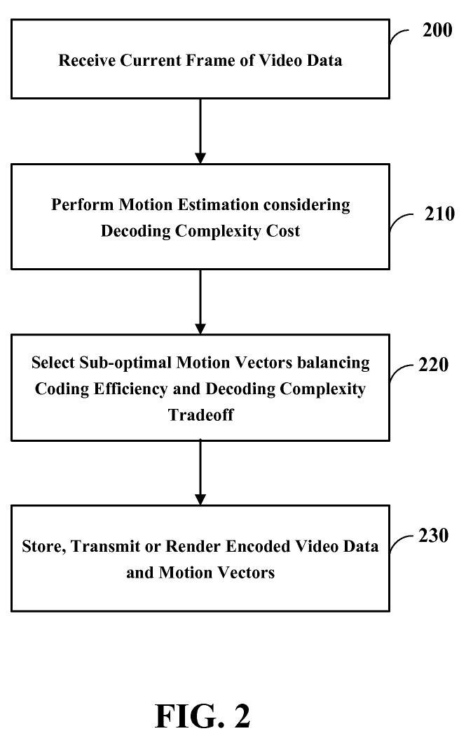

As shown by the flow diagram of FIG. 2, at 200, a current frame of video data is received by an encoder. At 210, motion estimation is performed considering decoding complexity as part of the algorithmic determination of motion vectors. At 220, sub-optimal motion vectors can be selected where a beneficial tradeoff between decoding complexity and reconstruction quality can be attained. At 230, the encoded video data and motion vectors can be further stored, transmitted, etc. and eventually decoded according to the complexity based decoding as described in one or more embodiments herein.

Various embodiments and further underlying concepts of the decoding complexity dependent encoding techniques are described in more detail below.

### Fractional Motion Estimation and Compensation

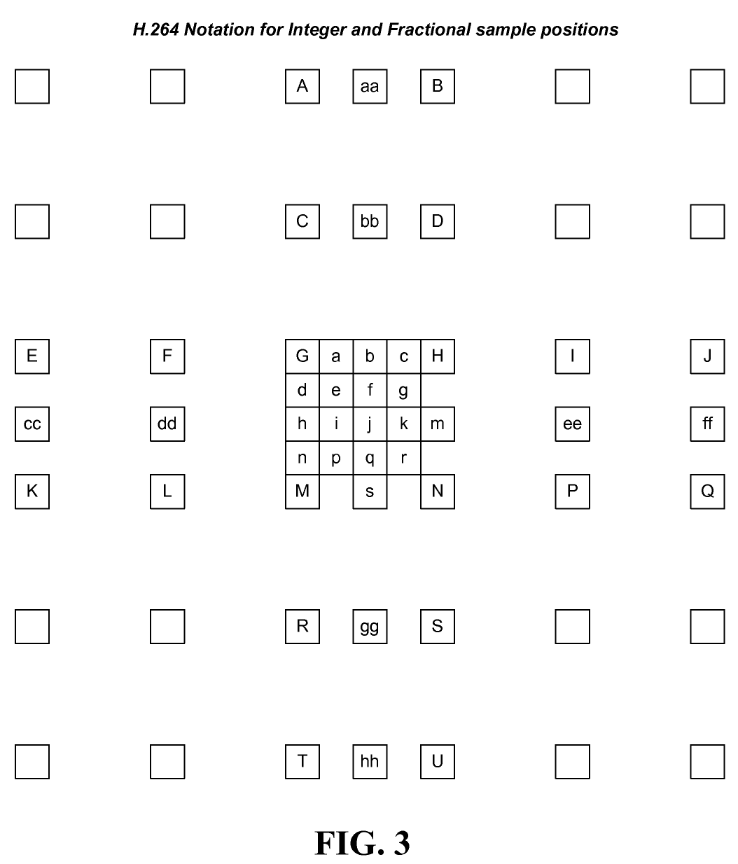

FIG. 3 sets forth some notation for integer samples and fractional sample positions in H.264/AVC. The capital letters indicate integer sample positions and the lower case letters indicate fractional sample positions, i.e., locations that can be specified “between samples.”

In this regard, quarter pixel motion vector accuracy improves the coding efficiency of H.264/AVC by allowing more accurate motion estimation and thus more accurate reconstruction of video. The half-pixel values can be derived by applying a 6-tap filter with tap values [1 −5 20 20 −5 1] and quarter-pixel values are derived by averaging the sample values at full and half sample positions during the motion compensation process. For example, the predicted value at the half-pixel position b is calculated with reference to FIG. 3 as:

b₁=E−5*F+20*G+20*H−5*I+J

b=Clip ((b₁+16)>>5)

For non-integer pixel locations, as compared with integer pixel positions, the computational complexity is much higher due to additional, complex multiplication and clipping operations that are performed for non-integer pixel locations. For instance, with a general purpose processor (GPP), such operations usually consume more clock cycles than other instructions, thus dramatically increasing decoder complexity.

To address the problem of increased computational complexity at the decoder introduced by calculations associated with non-integer pixel locations, as described herein for various embodiments, the complexity cost can be considered during motion estimation to avoid unnecessary interpolations. Instead of choosing the motion vector with optimal rate-distortion (R-D) performance, a sub-optimal motion vector with lower complexity cost can be selected. An efficient encoding scheme thus achieves a balance between coding efficiency and decoding complexity.

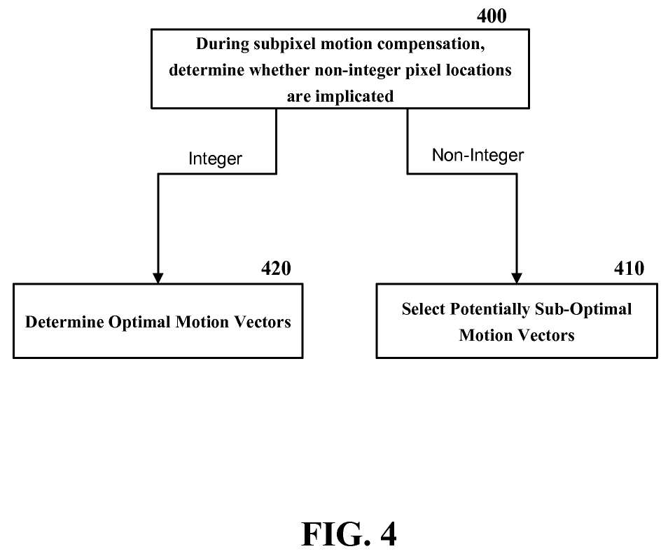

FIG. 4 is an exemplary flow diagram of a process for performing motion estimation for video encoding. At 400, for motion vector determination, first it is determined whether the motion estimation implicates a non-integer pixel location. If so, then at 410, a sub-optimal motion vector can be selected where unnecessary decoder operations of high complexity can be avoided. For integer pixel locations, optimal motion vectors can be selected at 420.

Complexity adaptive encoding methodology is described herein employing a modified rate-distortion optimization framework for achieving an effective balance between coding efficiency and decoding complexity. Rate-distortion optimization frameworks have been adopted in lossy video coding applications to improve coding efficiency at minimal expense to quality, with the basic idea being to minimize distortion D subject to a rate constraint. The Lagrangian multiplier method is a common approach. With such a Lagrangian multiplier approach, the motion vector, which minimizes the R-D cost, is selected according to the following Equation 1:

J_{Motion}^{R,D}=D_{DFD}+λ_{Motion}R_{Motion} Equation 1

where J_{Motion}^{R,D} is the joint R-D cost, D_{DFD} is the displaced frame difference between the input and the motion compensated prediction, and R_{Motion} is the estimated bit-rate associated with the selected motion vector. Similarly, the joint R-D cost for mode decision is given by Equation 2:

J_{Mode}^{R,D}=D_{Rec}+λ_{Mode}R_{Mode} Equation 2

The value of λ_{Mode} is determined empirically. The relationship between λₘₒₜᵢₒₙ and λ_{Mode} is adjusted according to Equation 3:

λ_{Motion}=\sqrt{λ_{Mode}} Equation 3

if SAD and SSD are used during the motion estimation and mode decision stage, respectively.

As mentioned, to factor decoder complexity into the motion estimation stage, a modified rate-distortion-complexity optimization is described herein. With the various embodiments of the joint R-D-C optimization framework for sub-pixel refinement, the complexity cost for each sub-pixel location is accounted for in the joint RDC cost function as given by Equation 4:

J_{Motion}^{R,D,C}=J_{Motion}^{R,D}+λ_{C}C_{Motion} Equation 4

Accordingly, the joint RDC cost is minimized during the subpixel motion estimation stage. When λ_{C}=0, it is observable from Equation 4 that the importance of the complexity factor on the outcome is minimal and can be neglected. In such case, the optimal R-D optimization framework can be retained to compute the optimal motion vectors.

In this regard, the complexity cost C_{Motion} is determined by the theoretical computational complexity of the obtained motion vector based on Table 1 set forth below. Table 1 illustrates subpixel locations, along with corresponding locations in FIG. 3, and the associated cost metric of interpolation complexity as a function of taps, or computational time delay units, e.g., either 6-tap operations or 2-tap operations.

TABLE 1
Subpixel Locations and Associated Interpolation Complexity

| Location (quarter-pel accuracy) | Notation | Cost |
|---|---|---|
| (0, 0) | G | 0 |
| (0, 2) (2, 0) | b, h | 1 * 6-tap |
| (0, 1) (1, 0) (0, 3) (3, 0) | a, c, d, n | 1 * 6-tap, 1 * 2-tap |
| (1, 1) (1, 3) (3, 1) (3, 3) | e, g, p, r | 2 * 6-tap, 1 * 2-tap |
| (2, 2) | j | 7 * 6-tap |
| (2, 1) (1, 2) (3, 2) (2, 3) | i, f, k, q | 7 * 6-tap, 1 * 2-tap |

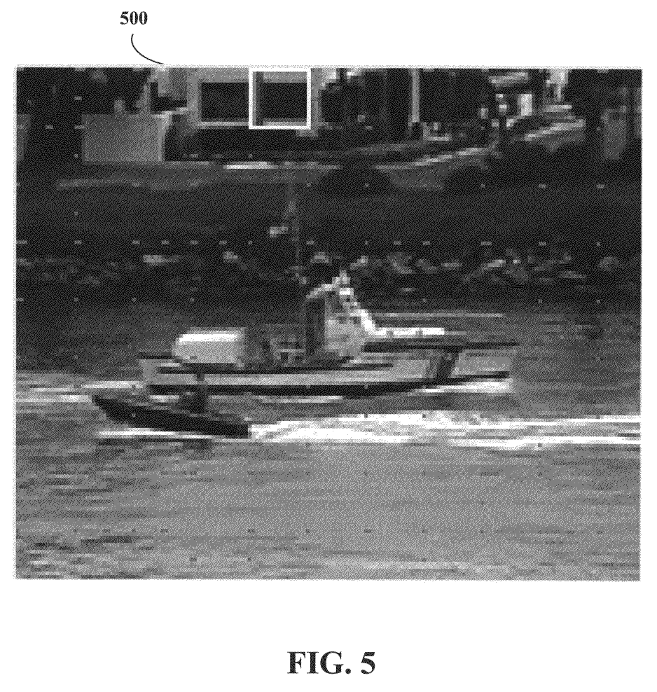

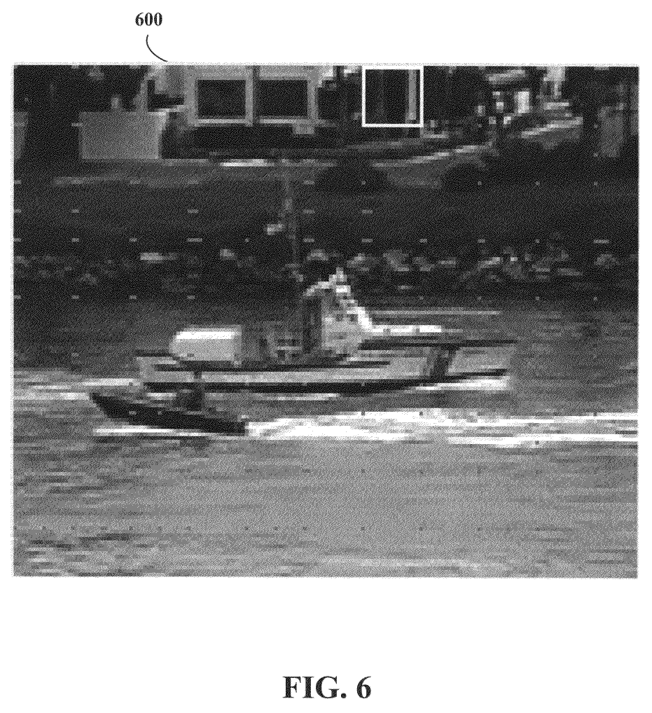

FIGS. 5 and 6 give a visualization of the resultant motion field that occurs without and with the adaptive complexity techniques described herein, respectively. FIG. 5 illustrates an image 500 that is reconstructed with an R-D-C optimization framework that always optimizes motion vectors and shows a visualization of a first resultant motion field. FIG. 6 in turn illustrates image 600 reconstructed from the same original image used to generate image 500 of FIG. 5, but using the adaptive complexity techniques that also consider decoder complexity during subpixel motion estimation and shows a visualization of a second resultant motion field.

Although the optimization framework illustrated in FIG. 5 is optimal locally, the resultant sub-optimal motion vectors may disfavor the overall coding efficiency. Such effect is especially significant in low bit rate situations in which motion vector cost tends to dominate over the residue cost.

Thus, to avoid motion field artifacts generated by the conventional framework, a multiple reference frames technique can be employed in various non-limiting embodiments. In this regard, an objective for the methods described herein is to preserve the correctness of the motion vectors. Thus, in one embodiment, the joint RDC cost is minimized within the selection of the best reference index per Equation 5, as follows:

$$Ref = arg {min}_{refidx} \{ {J}_{Motion}^{R , D} ( {V}_{refidx} ) + {λ}_{C} {C}_{Motion} ( {V}_{refidx} ) \} \qquad Equation 5$$

where V_{refidx} refers to the R-D optimized motion vector with reference index refidx and Ref is the optimal reference index. The joint RDC optimization framework is applied along the reference index selection process instead of the subpixel estimation process such that the motion vectors represent the true motion, assuming success of the motion estimation.

For example, for sample video content with constant object motion of one half pixel displacement to the left for each frame, coding as {(4,0):1} instead of {(2,0):0} can represent the real motion information while reducing the interpolation complexity. With the notation, the number in the bracket represents the x and y component of the motion vector, respectively, and the remaining number refers to the reference index.

As mentioned, image 600 of FIG. 6 visualizes the motion vectors with the complexity based method described herein, which shows a smooth region at the top-left region with motion vectors with greater magnitude, but lower interpolation complexity. Hence, a chaotic motion field generated by sub-optimal motion vectors can be avoided.

A new complexity cost model is thus utilized. According to Table 1, interpolating position j requires 7 6-tap operations, but it takes only

(6+w−1)*h+w*h

6-tap operations for a block with width w and height h, that is, 52 operations for a 4×4 block, for example, which translates to an average of 3.25 6-tap operations for each pixel. Therefore, the new estimated complexity cost is given by Equations 6 and 7:

$${C}^{′} = [ \begin{matrix}1 & 12 & 10 & 12 \\ 12 & 24 & 39 & 24 \\ 10 & 39 & 35 & 39 \\ 12 & 24 & 39 & 24\end{matrix} ] \qquad Equation 6$$

C_{Motion}(MVₓ,MV_{y})=C′_{MV}_{ₓ}_{&3,MV}_{_{y}}_{&3} Equation 7

where the operator & refers to bitwise AND operation. Adjustments are made accounting for the complexity cost of addition and shifting operations and further adjustments can be made according to the current block mode.

The lagrangian multiplier λ_{C} is derived experimentally according to assumptions made and is expressed according to the relationship of Equation 8:

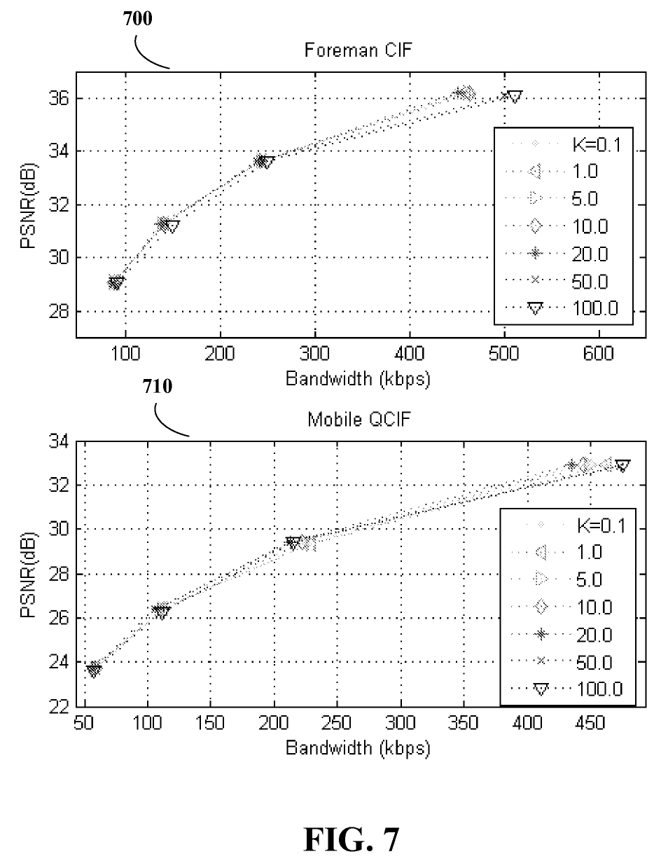

ln(λ_{C})=K−D_{DFD} Equation 8

where K is a constant that characterizes the video context. Such relationship has been verified for various sequences with different quality as shown in FIG. 7, a first sequence represented in graph 700 and a second sequence represented in graph 710. FIG. 7 thus illustrates how R-D performance varies for different choices of K.

In one non-limiting implementation, the value for K is determined to be around 20 empirically, avoiding extremes at either end, however such example is non-limiting on the general techniques described herein. In this regard, large λ_{C} values degrade the R-D performance while small values may result in a sudden change in selection of reference frame and hence higher motion vector cost.

The objective of the simulations is to demonstrate the usefulness of the proposed multiple reference frames complexity optimization technique. The R-D-C performance of the proposed scheme can also be compared with the original R-D optimization framework.

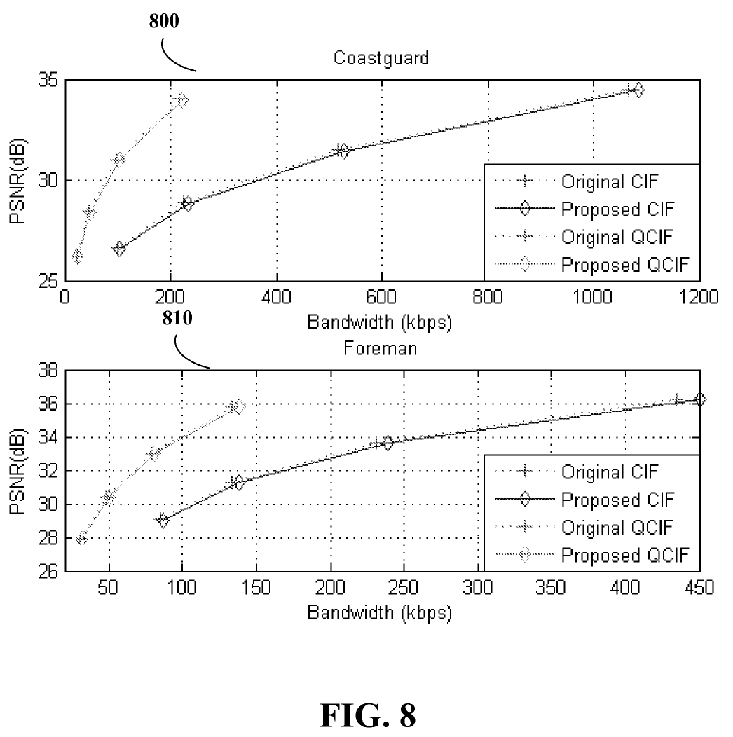

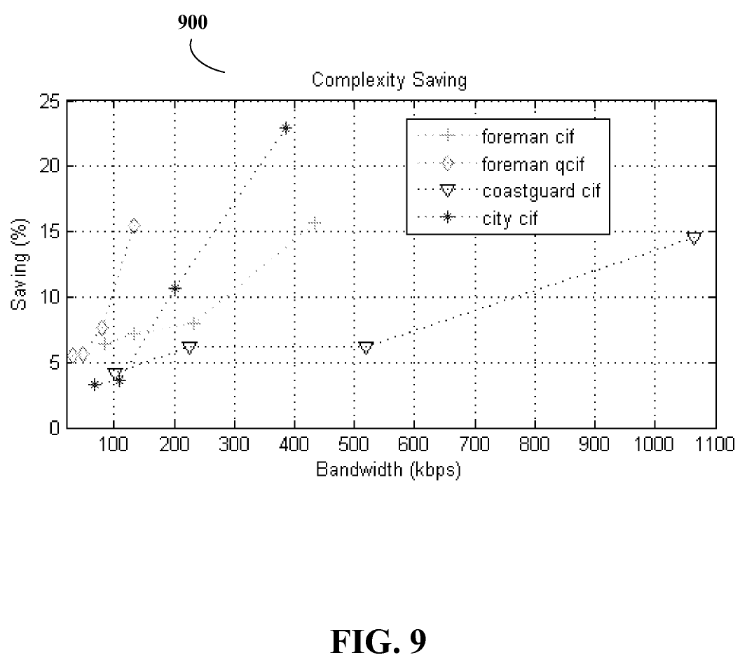

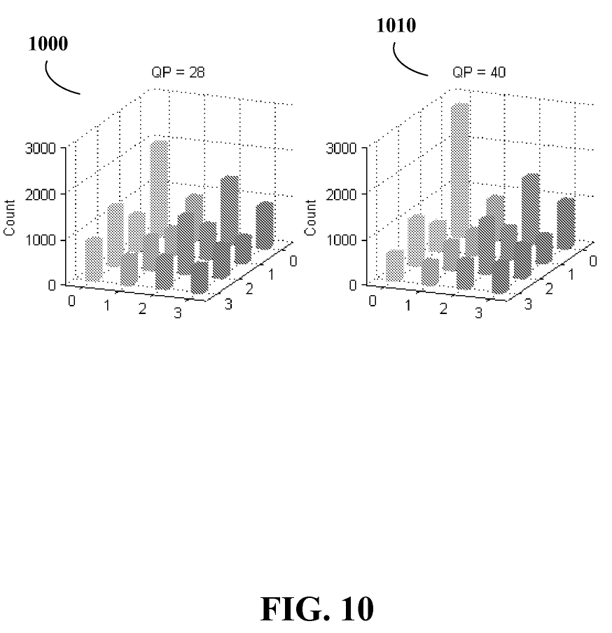

FIG. 8 shows the comparison of the R-D performance between the adaptive algorithm proposed herein and an original full-search method for a first testing sequence represented by graph 800 and a second testing sequence represented by graph 810. Generally, the performance degradation is around 0.1 dB and even lower for low bit-rate situations. And, depending on the bit-rate and the motion characteristics, complexity savings for decoding using the techniques described herein varies in the range of about 5% to about 20%, as shown by graph 900 of FIG. 9. FIG. 9 shows that the savings is more significant at a higher bit-rate, since the motion vector accuracy is higher, relatively speaking, at a higher bit-rate and therefore distributed more uniformly over the subpixel locations. This is shown in FIG. 10 for quantization parameter of 28 and 40 for 3-D graphs 1000 and 1010, respectively, where Position (0, 0) refers to integer pixel location G, as given in Table 1.

For many of the testing sequences, the video content includes a stationary background and therefore motion vectors are biased at the (0,0) position. Thus, in such circumstances, room for improvement for further complexity savings can be limited. Such effect is further demonstrated by the City sequence in graph 900 of FIG. 9 with its relatively high complexity savings as global motions dominate.

Herein, various embodiments of a complexity adaptive encoding algorithm have been set forth that select an optimal reference that exhibits threshold decoding complexity savings. A full-search was used by comparison to demonstrate the benefits of reducing decoding complexity. Combining such technique with some fast motion estimation algorithms with some reference frame biasing techniques achieves even lower encoding and decoding complexity.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with efficient video encoding and/or decoding processes provided in accordance with the present invention. The present invention may apply to an environment with server computers and client computers deployed in a network environment or a distributed computing environment, having remote or local storage.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may request the efficient encoding and/or decoding processes of the invention.

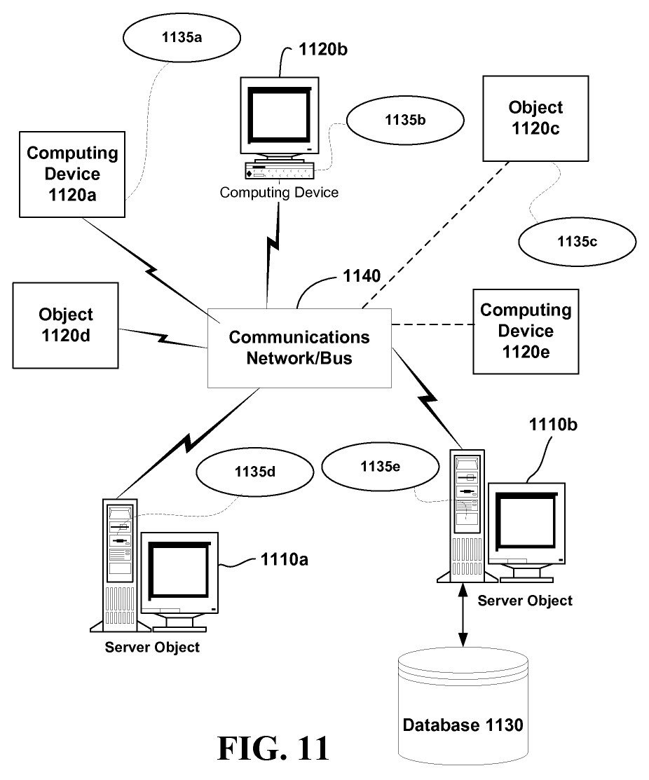

FIG. 11 provides a schematic diagram of an exemplary networked or distributed computing environment. The distributed computing environment comprises computing objects 1110a, 1110b, etc. and computing objects or devices 1120a, 1120b, 1120c, 1120d, 1120e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1140. This network may itself comprise other computing objects and computing devices that provide services to the system of FIG. 11, and may itself represent multiple interconnected networks. In accordance with an aspect of the invention, each object 1110a, 1110b, etc. or 1120a, 1120b, 1120c, 1120d, 1120e, etc. may contain an application that might make use of an API, or other object, software, firmware and/or hardware, suitable for communication with efficient encoding and/or decoding processes provided in accordance with the invention.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to the efficient encoding and/or decoding processes of the present invention.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 11, as an example, computers 1120a, 1120b, 1120c, 1120d, 1120e, etc. can be thought of as clients and computers 1110a, 1110b, etc. can be thought of as servers where servers 1110a, 1110b, etc. maintain the data that is then replicated to client computers 1120a, 1120b, 1120c, 1120d, 1120e, etc., although any computer can be considered a client, a server, or both, depending on the circumstances. Any of these computing devices may be processing data, recording measurements or requesting services or tasks that may implicate the efficient encoding and/or decoding processes in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for performing encoding or decoding of the invention may be distributed across multiple computing devices or objects.

In a network environment in which the communications network/bus 1140 is the Internet, for example, the servers 1110a, 1110b, etc. can be Web servers with which the clients 1120a, 1120b, 1120c, 1120d, 1120e, etc. communicate via any of a number of known protocols such as HTTP. Servers 1110a, 1110b, etc. may also serve as clients 1120a, 1120b, 1120c, 1120d, 1120e, etc., as may be characteristic of a distributed computing environment.

### Exemplary Computing Device

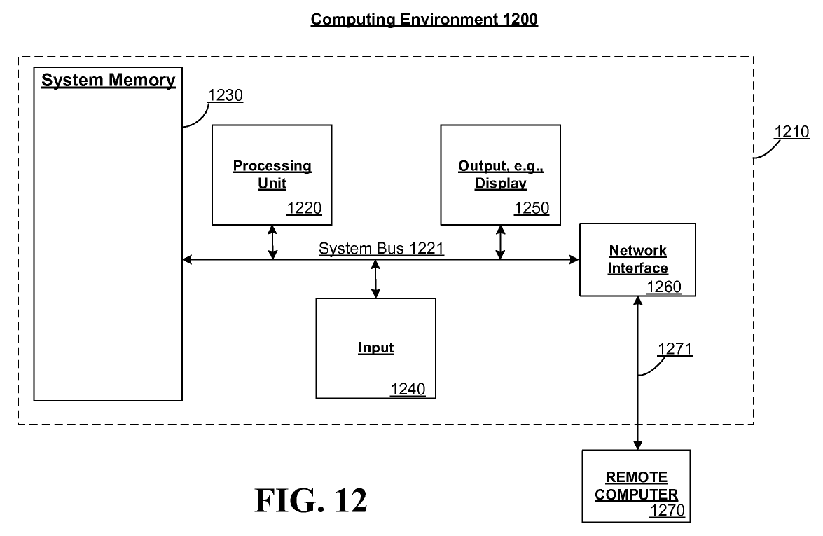

As mentioned, the invention applies to any device wherein it may be desirable to request network services. It should be understood, therefore, that handheld, portable and other computing devices and computing objects of all kinds are contemplated for use in connection with the present invention, i.e., anywhere that a device may request efficient encoding and/or decoding processes for a network address in a network. Accordingly, the below general purpose remote computer described below in FIG. 12 is but one example, and the present invention may be implemented with any client having network/bus interoperability and interaction.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 12 thus illustrates an example of a suitable computing system environment 1200 in which the invention may be implemented, although as made clear above, the computing system environment 1200 is only one example of a suitable computing environment and is not intended to suggest any limitation as to the scope of use or functionality of the invention. Neither should the computing environment 1200 be interpreted as having any dependency or requirement relating to any one or combination of components illustrated in the exemplary operating environment 1200.

With reference to FIG. 12, an exemplary remote device for implementing the invention includes a general purpose computing device in the form of a computer 1210. Components of computer 1210 may include, but are not limited to, a processing unit 1220, a system memory 1230, and a system bus 1221 that couples various system components including the system memory to the processing unit 1220.

Computer 1210 typically includes a variety of computer readable media and can be any available media that can be accessed by computer 1210. The system memory 1230 may include computer storage media in the form of volatile and/or nonvolatile memory such as read only memory (ROM) and/or random access memory (RAM). By way of example, and not limitation, memory 1230 may also include an operating system, application programs, other program modules, and program data.

A user may enter commands and information into the computer 1210 through input devices 1240 A monitor or other type of display device is also connected to the system bus 1221 via an interface, such as output interface 1250. In addition to a monitor, computers may also include other peripheral output devices such as speakers and a printer, which may be connected through output interface 1250.

The computer 1210 may operate in a networked or distributed environment using logical connections to one or more other remote computers, such as remote computer 1270. The remote computer 1270 may be a personal computer, a server, a router, a network PC, a peer device or other common network node, or any other remote media consumption or transmission device, and may include any or all of the elements described above relative to the computer 1210. The logical connections depicted in FIG. 12 include a network 1271, such local area network (LAN) or a wide area network (WAN), but may also include other networks/buses. Such networking environments are commonplace in homes, offices, enterprise-wide computer networks, intranets and the Internet.

As mentioned above, while exemplary embodiments of the present invention have been described in connection with various computing devices and network architectures, the underlying concepts may be applied to any network system and any computing device or system in which it is desirable to encode or compress video data.

There are multiple ways of implementing the present invention, e.g., an appropriate API, tool kit, driver code, operating system, control, standalone or downloadable software object, etc. which enables applications and services to use the efficient encoding and/or decoding processes of the invention. The invention contemplates the use of the invention from the standpoint of an API (or other software object), as well as from a software or hardware object that provides efficient encoding and/or decoding processes in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While the present invention has been described in connection with the preferred embodiments of the various figures, it is to be understood that other similar embodiments may be used or modifications and additions may be made to the described embodiment for performing the same function of the present invention without deviating therefrom. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for encoding video data, comprising:
receiving current frame data of image frame data representing a sequence of images;
determining at least one computational complexity cost associated with decoding the current frame data after the current frame data is encoded; and
encoding the current frame data based on data from at least one reference frame including encoding the current frame data based on the at least one computational complexity cost of decoding the current frame data.

2. The method of claim 1, wherein the encoding includes performing motion estimation that determines motion vectors for inter frame prediction based on temporal dependencies between frames of the sequence of images.

3. The method of claim 2, wherein the performing of motion estimation includes performing subpixel motion estimation taking into account motion estimates at locations between pixels of the image frame data.

4. The method of claim 3, wherein the performing of subpixel motion estimation includes minimizing a joint rate-distortion-complexity cost function.

5. The method of claim 2, wherein the performing of motion estimation includes determining the motion vectors based on a cost metric representing resulting computational decoding complexity.

6. The method of claim 2, wherein the performing motion estimation includes selecting an optimal reference index for rate-distortion optimized motion vectors.

7. The method of claim 1, wherein the encoding includes encoding according to the H.264 video coding standard.

8. The method of claim 1 further comprising:
determining the at least one reference frame including a biasing process for selecting reference frames for the at least one reference frame.

9. A computer readable medium comprising computer executable instructions for performing the method of claim 1.

10. Decoding apparatus for decoding image frame data encoded according to the method of claim 1.

11. A video encoding computing system for encoding video data, comprising:
at least one processor for processing a plurality of frames of video data; and
an encoding component that encodes the plurality of frames of video data, wherein the encoding component includes a motion estimation component for temporally compressing the plurality of frames of video data by estimating motion vectors for the plurality of frames, wherein the motion estimation component selects a sub-optimal motion vector as a function of at least one measure of computational complexity or cost associated with decoding at least one frame of the plurality of frames encoded by the encoding component.

12. The video encoding computing system of claim 11, wherein the motion estimation component estimates motion vectors with subpixel precision.

13. The video encoding computing system of claim 12, wherein the motion estimation component estimates motion vectors with at least one of quarter pixel or half pixel precision.

14. The video encoding computing system of claim 11, wherein the motion estimation component selects a sub-optimal motion vector as a function of at least one measure of an associated number of interpolation operations to be performed when decoding the at least one frame encoded by the encoding component.

15. The video encoding computing system of claim 11, wherein the motion estimation component selects either a rate-distortion optimized motion vector or a sub-optimal motion vector as a threshold function applied to the at least one measure of computational complexity.

16. The video encoding computing system of claim 15, wherein the encoding component selects an optimal reference index for rate-distortion optimized motion vectors.

17. The video encoding computing system of claim 11, wherein the encoding component encodes according to the H.264 video coding standard.

18. The video encoding computing system of claim 11, further comprising:
a decoding component for decoding frames of video data encoded according to the encoding of the encoding component.

19. Graphics processing apparatus, including:
means for receiving current frame data of image frame data representing a sequence of images; and
means for encoding the current frame data based on data from at least one reference frame including encoding the current frame data based on an expected computational cost of performing operations during decoding of the current frame data.

20. Graphics processing apparatus according to claim 19, wherein the means for encoding the current frame data encodes based on an expected cost of performing interpolation operations during decoding.
